(19) United States
(12) Patent Application Publication
(10) Pub. No.: US 2016/0305177 A1
(43) Pub. Date: Oct. 20, 2016

(54) PINCHING DETECTION DEVICE

(71) Applicant: AISIN SEIKI KABUSHIKI KAISHA, Kariya-shi (JP)

(72) Inventors: Hironori KOEDA, Gifu-shi (JP); Tomoki KAMEYAMA, Kariya-shi (JP); Kanehiro NAGATA, Kariya-shi (JP); Yuichi SAKANOUE, Toyota-shi (JP)

(73) Assignee: AISIN SEIKI KABUSHIKI KAISHA, Kariya-shi (JP)

(21) Appl. No.: 15/097,905

(22) Filed: Apr. 13, 2016

(30) Foreign Application Priority Data
Apr. 16, 2015 (JP) 2015-084164

(51) Int. Cl. E05F 15/48

(52) U.S. Cl. CPC E05F 15/48; E05Y 2900/531

(57) ABSTRACT

A pinching detection device detecting that foreign substances are caught between an opening and closing member for opening and closing an opening portion and a frame member surrounding the opening portion, includes: a sensor that is formed in an elongated shape and is capable of detecting that an external force acts on an outer peripheral surface thereof in a direction perpendicular to a longitudinal direction; and a holding member that has a sensor holding portion for holding the sensor and a gripping portion for gripping a plate-shaped portion formed in the opening and closing member or the frame member, wherein the sensor holding portion is formed of a synthetic resin material and the gripping portion is formed of a synthetic rubber material.

### CROSS REFERENCE TO RELATED APPLICATIONS

This application is based on and claims priority under 35 U.S.C. §119 to Japanese Patent Application 2015-084164, filed on Apr. 16, 2015, the entire contents of which are incorporated herein by reference.

### TECHNICAL FIELD

This disclosure generally relates to a pinching detection device detecting that foreign substances are caught between an opening and closing member (for example, a sliding door) for opening and closing an opening portion (for example, an entrance of a vehicle) and a frame member of the opening portion.

### BACKGROUND DISCUSSION

Conventionally, for example, as described in JP 2004-176426A (Reference 1), a pinching detection device detecting that foreign substances are caught between a door and a frame member configuring a door opening portion when closing the door of a vehicle has been known. The pinching detection device includes a sensor detecting that an external force acts and a holding member holding the sensor. The sensor is elastically deformed if the external force acts on an outer peripheral surface thereof. Electrode wires are disposed on the inside of the sensor and an electric resistance value of the electrode wires is changed by the elastic deformation.

The holding member has a sensor holding portion holding the sensor and a gripping portion gripping an edge of the door opening portion. The sensor holding portion has a groove portion extending along the edge of the door opening portion. That is, the groove portion has two wall portions facing each other. The gripping portion is formed in the two wall portions. The gripping portion has lip portions respectively protruding from surfaces of the two wall portions facing each other. The lip portions grip a flange portion formed along the edge of the door opening portion.

The holding portion and the gripping portion are integrally formed of synthetic rubber material. Generally, since the synthetic rubber material is more expensive than a synthetic resin material, the price of the pinching detection device is increased.

### SUMMARY

Thus, a need exists for an inexpensive pinching detection device which is not suspectable to the drawback mentioned above. In the description of each configuration element of this disclosure described below, in order to facilitate understanding of this disclosure, a numeral of the corresponding portion of an embodiment is described in parentheses. However, it should not be interpreted that each configuration element of this disclosure is limited to the configuration of the corresponding portion indicated by the numeral of the embodiment.

An aspect of this disclosure is directed to a pinching detection device (10) detecting that foreign substances are caught between an opening and closing member (SD) for opening and closing an opening portion (DW) and a frame member (PN) surrounding the opening portion, the pinching detection device including a sensor (20) that is formed in an elongated shape and is capable of detecting that an external force acts on an outer peripheral surface thereof in a direction perpendicular to a longitudinal direction; and a holding member (30) that has a sensor holding portion (31) for holding the sensor and a gripping portion (32) for gripping a plate-shaped portion (SDa) formed in the opening and closing member or the frame member. The sensor holding portion is formed of a synthetic resin material and the gripping portion is formed of a synthetic rubber material.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating an outline of a vehicle to which a pinching detection device according to one embodiment disclosed here is applied;

FIG. 2 is a perspective view of a sliding door;

FIG. 3 is a sectional view that is taken along line III-III of FIG. 2;

FIG. 4 is a sectional view illustrating a cross section perpendicular to a longitudinal direction of the pinching detection device according to one embodiment disclosed here; and

FIG. 5 is a sectional view illustrating a cross section perpendicular to a longitudinal direction of the pinching detection device according to a modification example disclosed here.

### DETAILED DESCRIPTION

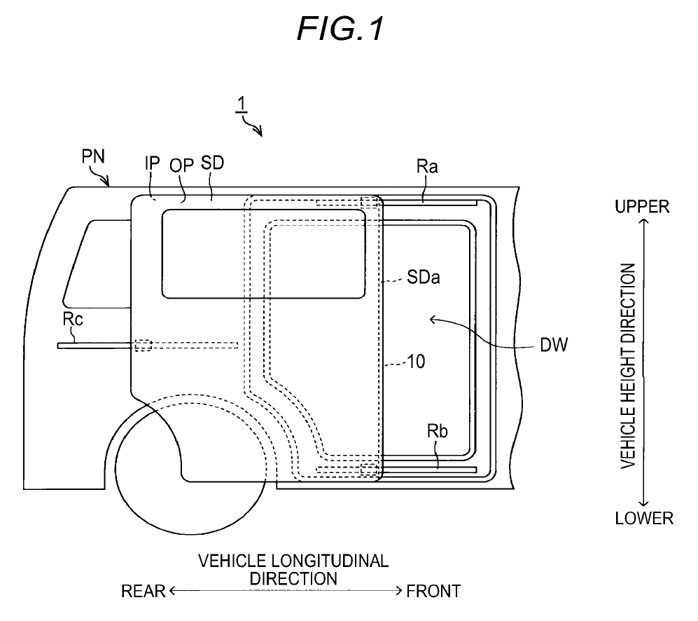

A pinching detection device 10 according to one embodiment of this disclosure will be described. As illustrated in FIG. 1, the pinching detection device 10 is applied to a sliding door device of a vehicle. First, an outline of the vehicle will be described. The sliding door device is provided in a side surface portion on a right side of the vehicle. An entrance DW is formed in a panel PN configuring an outer contour of a vehicle body portion 1. An upper rail Ra and a lower rail Rb are respectively extended in a vehicle longitudinal direction along an upper edge and a lower edge of the entrance DW. In addition, a center rail Rc is extended in the vehicle longitudinal direction in the vicinity of the center portion in a vehicle height direction in a rear of the entrance DW. A sliding door SD is supported on the upper rail Ra, the lower rail Rb, and the center rail Rc, and is capable of moving in the vehicle longitudinal direction along the upper rail Ra, the lower rail Rb, and the center rail Rc. The sliding door SD is connected to a driving device (not illustrated) and is driven by the driving device, and therefore, the sliding door is moved in the vehicle longitudinal direction, and then opens and closes the entrance DW. Moreover, the entrance DW corresponds to the opening portion of this disclosure and the panel PN corresponds to the frame member of this disclosure. In addition, the sliding door SD corresponds to the opening and closing member of this disclosure.

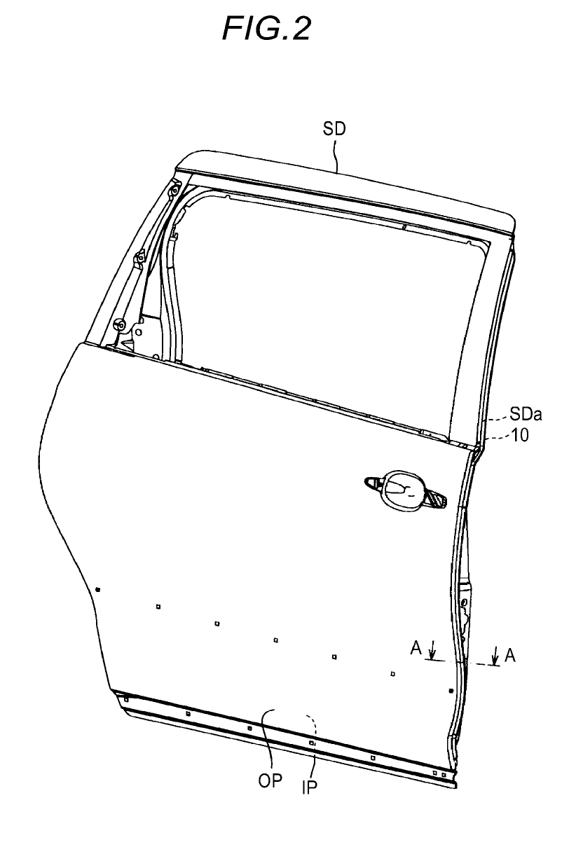

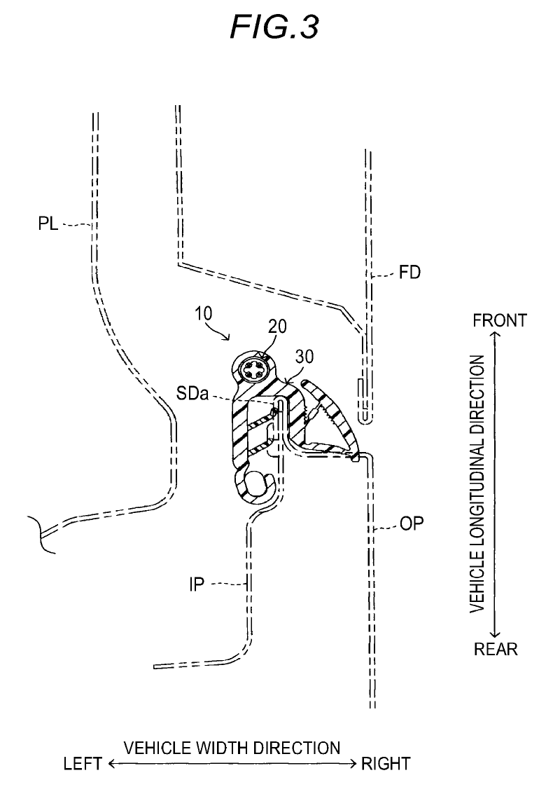

As illustrated in FIGS. 2 and 3, the sliding door SD is formed by bonding an edge portion of an outer panel OP disposed on the right side and an edge portion of an inner panel IP disposed on the left side. The outer panel OP and the inner panel IP are formed by pressing so that a space is formed within the sliding door SD in a state of bonding the outer panel OP and the inner panel IP. A bonding portion SDa of the outer panel OP and the inner panel IP in a front end edge of the sliding door SD is extended in the vehicle height direction and is formed in a plate shape perpendicular to a vehicle width direction. The bonding portion SDa corresponds to the plate-shaped portion of this disclosure.

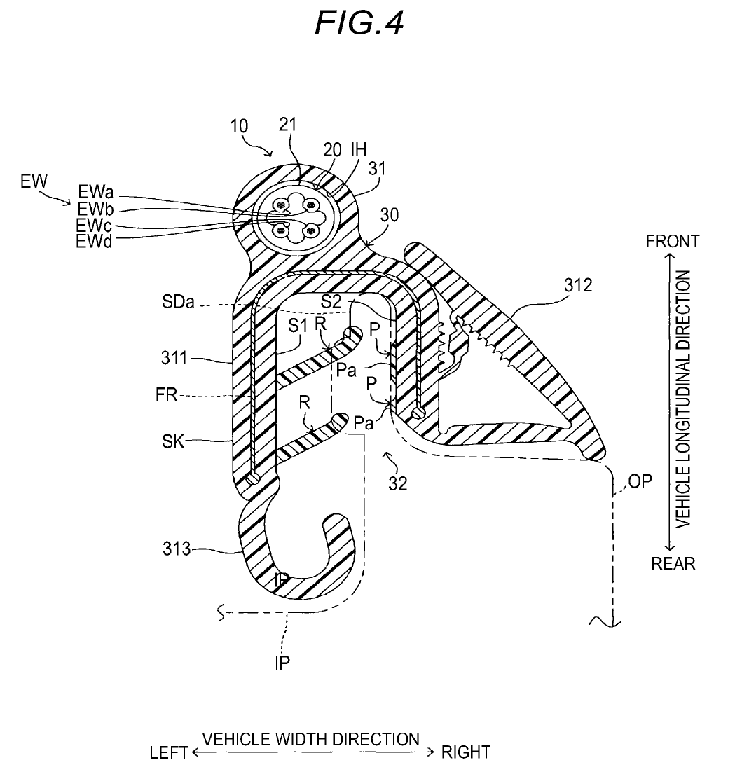

Next, a configuration of the pinching detection device 10 will be described. In the following description, various directions are directions in a state in which the pinching detection device 10 is mounted on the vehicle body (sliding door SD). As illustrated in FIG. 4, the pinching detection device 10 includes a sensor 20 and a holding member 30 that holds the sensor 20 and grips the bonding portion SDa. The sensor 20 has an outer skin portion 21 and electrode wires EWa, EWb, EWc, and EWd disposed on the inside of the outer skin portion 21. The outer skin portion 21 is formed in a tube shape extended in the vehicle height direction by extruding an elastic material having electrical insulation. An external shape of a cross section of the outer skin portion 21 perpendicular to the longitudinal direction has a circular shape. The electrode wires EWa, EWb, EWc, and EWd are respectively extended along the longitudinal direction of the outer skin portion 21 on the inside of the outer skin portion 21 and are fixed to an inner peripheral surface of the outer skin portion 21 in a state of being separated from each other.

The electrode wires EWa, EWb, EWc, and EWd are configured of core wire portions that are formed by twisting metal wires (for example, copper wires) and covering portions that are formed of conductive rubber and cover the core wire portions. One ends of the electrode wire EWa and the electrode wire EWb are electricity connected and the other ends of the electrode wire EWb and the electrode wire EWc are electrically connected. In addition, one end of the electrode wire EWc and one end of the electrode wire EWd are electrically connected. The other ends of the electrode wire EWa and the electrode wire EWd are electrically connected to a connector (not illustrated). That is, the electrode wires EWa, EWb, EWc, and EWd configure one electrode wire EW. In other words, the electrode wires EWa, EWb, EWc, and EWd configure one electrical resistor. One end of a harness (not illustrated) is connected to the connector of the electrode wire

EW. The harness is inserted from a through-hole (not illustrated) formed on a front end surface of the sliding door SD into the sliding door SD. The other end of the harness is connected to the driving device.

The holding member 30 is formed in an elongated shape extending in the vehicle height direction. The holding member 30 has a sensor holding portion 31 that holds the sensor 20 and a gripping portion 32 that grips the bonding portion SDa. The sensor holding portion 31 has an insertion hole IH extending along the longitudinal direction. The sensor 20 is inserted into the insertion hole IH to be held. An inner periphery edge of the insertion hole IH has a circular shape in a cross section perpendicular to the holding member 30 in the longitudinal direction. An inner diameter of the insertion hole IH is slightly greater than an outer diameter of the outer skin portion 21.

The sensor holding portion 31 has a groove portion 311 that is extended in the vehicle height direction and is formed in a groove shape opened upward, downward, and rearward. The groove portion 311 has a core member FR and an outer skin portion SK. The core member FR is formed in a groove shape that is extended in the vehicle height direction and is opened upward, downward, and rearward. The core member FR is a wire carrier formed in an elongated thin plate shape by causing a thin wire to meander at regular intervals. The core member FR is covered by the outer skin portion SK. The core member FR and the outer skin portion SK are integrally formed using an insert molding method. The gripping portion 32 described below is formed on the inside of the groove portion 311.

In addition, the sensor holding portion 31 has a seal portion 312. The seal portion 312 is formed in a right wall portion of the groove portion 311. The seal portion 312 blocks a gap between a front door FD and the sliding door SD and prevents the foreign substances from entering from the outside to a pillar PL side when closing the sliding door SD (see FIG. 3). In addition, the sensor holding portion 31 has a harness holding portion 313. The harness holding portion 313 is formed in a left wall portion of the groove portion 311. The harness holding portion 313 holds a portion of the harness on one end side.

The gripping portion 32 has lip portions R and convex portions P. The lip portions R are formed in a side surface S1 of the groove portion 311. The lip portions R protrude on the right side from the side surface S1 of the groove portion 311. In addition, the convex portions P are formed on a side surface S2 of the groove portion 311. The convex portions P slightly protrude from the side surface S2 of the groove portion 311. The convex portions P have side surface portions Pa that are side surface portions formed in parallel to the right surface of the bonding portion SDa and are capable of abutting against the right surface of the bonding portion SDa.

The sensor holding portion 31 is formed of a soft synthetic resin material (for example, elastomer) and the gripping portion 32 (the lip portions R and the convex portions P) is formed of a synthetic rubber material. The sensor holding portion 31 and the gripping portion 32 are integrally formed using a two-color molding method.

The sensor 20 is inserted, as below, into the insertion hole IH of the sensor holding portion 31 of the holding member 30, which is configured as described above. High-pressure air is injected from one end of the insertion hole IH and the sensor 20 is inserted from the other end of the insertion hole IH. Then, the sensor 20 causes an increase in a resistance to flow of the high-pressure air and therefore an inner diameter of the insertion hole IH is slightly enlarged. That is, the sensor holding portion 31 is slightly expanded. Therefore, sliding resistance generated between an outer peripheral surface of the sensor 20 and an inner peripheral surface of the insertion hole IH is reduced and therefore the sensor 20 is easily inserted into the insertion hole IH.

The bonding portion SDa is gripped by the gripping portion 32 by inserting the bonding portion SDa into the groove portion 311 of the pinching detection device 10 assembled as described above. Then, one end of the harness is connected to the connector of the sensor 20. The driving device applies a constant voltage to the electrode wire EW and detects a current amount flowing through the electrode wire EW.

If the foreign substances are caught between the sliding door SD and the panel PN during a closing operation of the sliding door SD, the sensor holding portion 31 and the outer skin portion 21 of the sensor 20 are pressed and elastically deformed due to the foreign substances. Then, at least two electrode wires among the electrode wires EWa, EWb, EWc, and EWd are in contact with each other. Therefore, an electric resistance value of the electrode wire EW is reduced. Accordingly, the current amount flowing through the electrode wire EW is increased. The driving device determines that the foreign substances are caught and opens the sliding door SD if it is detected that the current amount flowing through the electrode wire EW is greater than that at a normal time.

As described above, in the embodiment, the gripping portion 32 is formed of the synthetic rubber material and the other portions are formed of the synthetic resin material that is inexpensive compared to the synthetic rubber material. Therefore, according to the embodiment disclosed here, it is possible to supply the pinching detection device 10 at a low cost compared to the related art. In addition, generally, in order to increase durability, when forming a member with the synthetic rubber material, it is often subjected to a vulcanization process. In the embodiment, since a portion that is formed of the synthetic rubber material is less than that in the related art is, it is possible to reduce the vulcanization process. In addition, since the gripping portion 32 is formed of the synthetic rubber material, the durability of the gripping portion 32 is increased compared to a case in which the gripping portion 32 is formed of the synthetic resin material. In addition, the left surface of the bonding portion SDa is pressed by the lip portions R and the right surface of the bonding portion SDa abuts against the side surface portions Pa of the convex portions P. Since the convex portions P are formed so as to slightly protrude from the side surface S2 of the groove portion 311, the convex portions P are unlikely to be elastically deformed compared to the lip portions R. Therefore, positional accuracy of the pinching detection device 10 in the vehicle width direction is increased.

Furthermore, the practice of the embodiment disclosed here is not limited to the embodiment described above and various modifications can be made without departing from the object of the embodiment disclosed here.

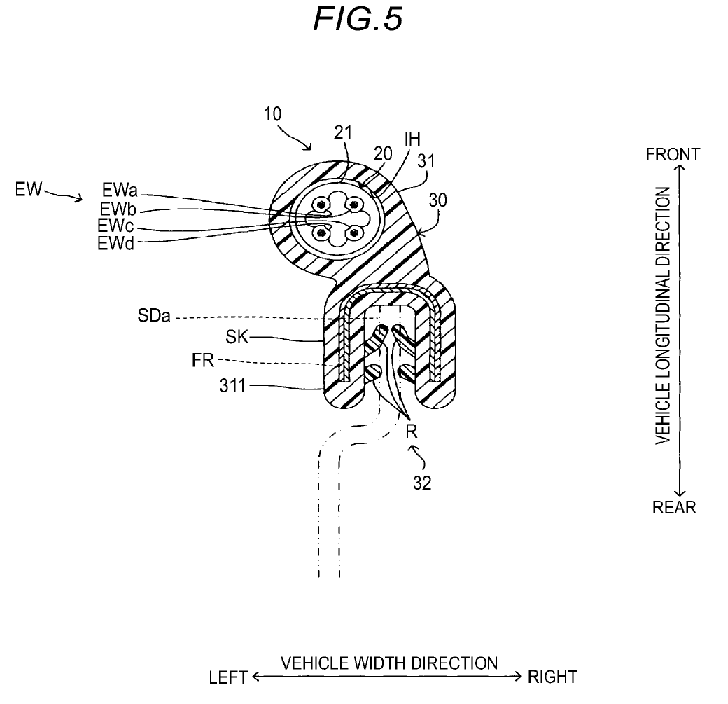

For example, the convex portions P described above may be changed to the lip portions R (see FIG. 5). That is, both side surfaces of the bonding portion SDa may be gripped by the lip portions R.

In addition, the pinching detection device 10 is not assembled to the sliding door SD but to the front edge portion of the entrance DW. Moreover, in the embodiment and modification example described above, the sliding door device is provided in the right side surface portion of the vehicle, but the embodiment disclosed here can be also applied to a sliding door device provided in a left side surface portion of the vehicle. In addition, in the embodiment and modification example described above, an example in which the pinching detection device 10 is applied to the sliding door device of the vehicle is described, but the pinching detection device of the embodiment disclosed here is not limited to the sliding door device of the vehicle and can also be applied to any door device.

An aspect of this disclosure is directed to a pinching detection device (10) detecting that foreign substances are caught between an opening and closing member (SD) for opening and closing an opening portion (DW) and a frame member (PN) surrounding the opening portion, the pinching detection device including a sensor (20) that is formed in an elongated shape and is capable of detecting that an external force acts on an outer peripheral surface thereof in a direction perpendicular to a longitudinal direction; and a holding member (30) that has a sensor holding portion (31) for holding the sensor and a gripping portion (32) for gripping a plate-shaped portion (SDa) formed in the opening and closing member or the frame member. The sensor holding portion is formed of a synthetic resin material and the gripping portion is formed of a synthetic rubber material.

In this case, it is preferable that the sensor holding portion includes a groove portion (311) into which the plate-shaped portion is inserted, and the gripping portion includes a lip portion (R) that is extended from one side surface of the groove portion and abuts against one side surface of the plate-shaped portion in a state of being elastically deformed, and a convex portion (P) that has an abutting surface (Pa) formed on the other side surface of the groove portion, parallel to the other side surface of the plate-shaped portion, and abutting against the other side surface of the plate-shaped portion.

In addition, in this case, it is preferable that the sensor holding portion includes a groove portion into which the plate-shaped portion is inserted, and the gripping portion includes a first lip portion that is extended from one side surface of the groove portion and abuts against one side surface of the plate-shaped portion in a state of being elastically deformed, and a second lip portion that is extended from the other side surface of the groove portion and abuts against the other side surface of the plate-shaped portion in a state of being elastically deformed.

In the pinching detection device according to the aspect of this disclosure, the gripping portion is formed of the synthetic rubber material and the sensor holding portion is formed of the synthetic resin material that is inexpensive compared to the synthetic rubber material. Therefore, according to this disclosure, it is possible to inexpensively provide the pinching detection device compared to the related art. In addition, generally, in order to improve durability when forming a member with the synthetic rubber material, it is often subjected to a vulcanization process. In the pinching detection device according to this disclosure, since a portion which is formed of the synthetic rubber material is smaller than that in the related art is, it is possible to shorten the vulcanization process. In addition, since the gripping portion is formed of the synthetic rubber material, the durability of the gripping portion is increased compared to a case in which the gripping portion is formed of the synthetic resin material.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A pinching detection device detecting that foreign substances are caught between an opening and closing member for opening and closing an opening portion and a frame member surrounding the opening portion, the pinching detection device comprising:
a sensor that is formed in an elongated shape and is capable of detecting that an external force acts on an outer peripheral surface thereof in a direction perpendicular to a longitudinal direction; and
a holding member that has a sensor holding portion for holding the sensor and a gripping portion for gripping a plate-shaped portion formed in the opening and closing member or the frame member,
wherein the sensor holding portion is formed of a synthetic resin material and the gripping portion is formed of a synthetic rubber material.

2. The pinching detection device according to claim 1,
wherein the sensor holding portion includes a groove portion into which the plate-shaped portion is inserted, and
wherein the gripping portion includes
a lip portion that is extended from one side surface of the groove portion and abuts against one side surface of the plate-shaped portion in a state of being elastically deformed, and
a convex portion that has an abutting surface formed on the other side surface of the groove portion, parallel to the other side surface of the plate-shaped portion, and abutting against the other side surface of the plate-shaped portion.

3. The pinching detection device according to claim 1,
wherein the sensor holding portion includes a groove portion into which the plate-shaped portion is inserted,
wherein the gripping portion includes
a first lip portion that is extended from one side surface of the groove portion and abuts against one side surface of the plate-shaped portion in a state of being elastically deformed, and
a second lip portion that is extended from the other side surface of the groove portion and abuts against the other side surface of the plate-shaped portion in a state of being elastically deformed.
